(19) United States
(12) Patent Application Publication
(10) Pub. No.: US 2021/0041011 A1
(43) Pub. Date: Feb. 11, 2021

(54) PLANETARY TRACTION DRIVE

(71) Applicant: ULTIMATE TRANSMISSIONS PTY LTD, New South Wales (AU)

(72) Inventor: Michael DURACK, Kaengkhoi Saraburi (TH)

(21) Appl. No.: 16/966,786

(22) PCT Filed: Jan. 25, 2019
(86) PCT No.: PCT/AU2019/050057

§ 371 Date: Jul. 31, 2020

(30) Foreign Application Priority Data
Jan. 31, 2018 (AU) 2018900298

(51) Int. Cl. F16H 13/08; F16H 13/12; F16H 13/14

(52) U.S. Cl. CPC F16H 13/08; F16H 13/14; F16H 13/12

(57) ABSTRACT

An epicyclic traction drive transmission, including a carrier 7 having a central axis, a sun shaft 9 rotationally mounted within carrier 7 and positioned in the central axis, a plurality of planet rollers 4 mounted on carrier 7 and arranged to rotate on respective angularly equidistant axles 5, and rotationally engage the sun shaft 9, and an outer ring 1. A wedge roller 2,3 associated with each planet roller 4 is free to translate relative to carrier 7; and engages outer ring 1 and respective planetary roller 4 with a frictional or traction coefficient μ, and the wedge roller 2,3 defining a wedging angle α, such that tan α/2 is less than μ. In one form there are two wedge rollers 2,3 for each planet roller, allowing for a wedging action in either direction of rotation.

### TECHNICAL FIELD

The present invention is concerned with epicyclic concentric friction and traction drives.

### BACKGROUND OF THE INVENTION

Traction drives (sometimes called friction drives) are drives in which hard cylindrical surfaces are used to transfer motion using the traction coefficient of a traction fluid located between the surfaces. While under low speed conditions the metal surfaces may engage each other, under load conditions at high speeds the metal surfaces do not engage directly, and the forces are transferred through the traction fluid that forms between the two rolling surfaces. The surface speeds at which the contact transitions from a frictional contact to one fully separated by fluid varies with the surface roughness of the rolling components and the amount of traction fluid being supplied to the rolling contacts but generally occurs at rolling speeds higher than 1 meter/second.

In one form traction drives take the form of an epicyclic system, consisting of a central sun (or sun shaft), a series of planet rollers and a ring outside on the planet rollers. In one form of these drives, the clamping force necessary to cause the high shear forces on the traction fluid, so that the fluid increases viscosity sufficiently under pressure to transfer force, is created elastically, for example as shown in U.S. Pat. No. 6,960,147 B2 (Rotrex). In another form, the clamping force is created using a form of torque responsive clamping action so that the clamping force is proportional to the torque being transmitted, and it is this type to which the present invention relates. One type of torque responsive clamping uses a form of actuation that cause conical surfaces to ride up on each other in an axial direction and create radially directed forces, for example as shown in U.S. Pat. No. 8,608,609 B2 (Van Dyne) and U.S. Pat. No. 6,095,940 (Timken).

The present invention is concerned with systems which use wedging rollers or wedging planets that wedge into the gap formed by the planet rollers and the ring and or the gap formed by the wedging rollers and the sun in such a way that the traction forces that develop at the wedging roller or planet contacts that wedge the wedging roller and or planet into the gap creating large clamping forces.

Within this group are concentric and eccentric variants. The eccentric variants place the sun off centre to the ring, for example as shown in U.S. Pat. No. 7,153,230 (Timken) and EP 0877181 A1 (NSK). The concentric arrangement is disclosed, for example, in U.S. Pat. No. 8,123,644 B2 (Kyocera) and U.S. Pat. No. 8,092,332 Ai (Timken).

U.S. Pat. No. 8,092,332 to Ai (Timken) describes a concentric epicyclic transmission, in which wedging rollers and wedging planets are provided to wedge into the gap between the planetary rollers and the ring. Ai discloses the use of a pivoting support for the planetary rollers and planets, in which the planet roller and wedge rollers are locked together in pairs and both rollers are mounted on respective axles. Ai specifies that the wedging angles α1 and α2 must be such that the tan of these angles is smaller than the friction coefficient. The wedging action and subsequent creation of large normal forces described in this patent is understood to occurr in the direction caused by traction forces on the surface of the ring, wedge rollers and planet and in the direction of the traction forces that develop between the wedging rollers planets and sun. For this reason it is sugested that the pivot support is placed generally centrally and with the planets and wedge rollers generally equal in size because these wedging forces act in the opposite direction to each other. Although not stated this allows this wedging action to occurr in only one direction.

U.S. Pat. No. 8,123,644 to Marumoto (Kyocera) discloses a concentric epicyclic transmission. The wedging rollers are described as engaging the outer ring, not as acting to wedge into the gap under the influence of the traction forces but in the opposite direction between the planetary rollers and the ring. Marumoto discloses the use of a pivoting support for the planetary rollers, in which the planet rollers and wedge rollers are locked together in pairs and are both rollers are mounted on respective axles. This disclosure also teaches that the mechanism can only accept torque in one direction, not both directions.

It is an object of the present invention to provide an improved concentric epicyclic traction transmission.

### SUMMARY OF THE INVENTION

In a first broad form, the present invention provides a wedging type epicyclic traction drive transmission, in which the wedge roller is free to translate relative to the carrier and in which the planets are not required to be wedged into any wedging gap but are supported directly by the carrier

According to one aspect, the present invention provides an epicyclic traction drive transmission, including a carrier having a central axis, a sun shaft rotationally mounted within the carrier and positioned in the central axis, a plurality of planet rollers mounted on the carrier and arranged to rotate on respective angularly equidistant axles, and rotationally engage the sun shaft; at least one wedge roller associated with each planet roller, the wedge roller being free to translate relative to the carrier; and an outer ring, co-axial with the central axis; wherein each wedge roller engages the outer ring and respective planetary roller with a frictional or traction coefficient μ, and the wedge roller defines a wedging angle α, such that tan α/2 is less than μ.

According to another aspect, the present invention provides an epicyclic traction drive transmission, including a carrier having a central axis, a sun shaft rotationally mounted within the carrier and positioned in the central axis, a plurality of planet rollers mounted on the carrier and arranged to rotate on respective angularly equidistant axles, and rotationally engage the sun shaft; a first and second wedge roller associated with each planet roller, each wedge roller being free to translate relative to the carrier; and an outer ring, co-axial with the central axis; wherein each pair of first and second wedge rollers are biased by a preload force into the respective gap between the ring and each side of the planet roller, so that a wedging force is operatively created between the wedge roller, the planet roller and ring regardless of the direction of rotation.

In suitable implementations, this allows for permitted wedging angle size to be increased, providing advantages in machining tolerances and hence precision of the transmission.

Further, using two wedge rollers allows for rotation in either direction with a wedging action, and further in suitable implementations the wedge rollers to be biased towards each other to readily provide a desired pre-load force to initiate the wedging action.

### BRIEF DESCRIPTION OF THE DRAWINGS

Illustrative implementations of the present invention will be described with reference to the accompanying figures, in which:

FIG. 1 is a schematic plan view of a first implementation of the present invention;

FIG. 1A is a simplified view similar to FIG. 1, to illustrate the wedging roller angle α1 and the associated forces;

FIG. 2 is a cross-sectional view of the implementation of FIG. 1;

FIG. 3 is a cross-sectional view of a second implementation;

FIG. 4 cross-sectional view of a third implementation;

FIG. 5 is a detailed view of the wedge rollers according to FIG. 1;

FIG. 6 is a detailed view of the wedge rollers according to FIG. 4;

FIG. 7 is a detailed view of wedge rollers according to the implementation of FIG. 3;

FIG. 8 is a cross section view of a device according to the implementation of FIG. 3;

FIG. 9 is a cross section view of a device according to a fourth implementation; and

FIG. 10 cross section view of a device according to a fifth implementation.

### DETAILED DESCRIPTION OF THE INVENTION

The present invention will be described with reference to the accompanying examples, which are illustrative of the implementations of the present invention, but not limitative of the scope of the invention. For example, the number of planet rollers and wedge rollers may be varied, the support and bearing arrangements may be varied as appropriate to specific applications, and the dimensions and materials used may vary with the specific requirements of particular applications of the present invention.

It is also important to understand that with conventional geared epicyclic systems using a sun, ring, planet and planet carrier twelve rotational states are possible and these are often used in mechanical systems.

1) Carrier fixed with torque input to the Sun and output the Carrier

2) Carrier fixed with torque into the Ring and output to the Sun

3) Sun fixed with torque input from Ring and Carrier output

4) Sun fixed and torque input to Carrier with Ring the output

5) Ring fixed with torque input to Carrier and output to Sun

6) Ring fixed with torque input to Sun and Carrier the output

7) Input torque to both Sun and Ring with Carrier output

8) Input torque to both Sun and Carrier with output to Ring

9) Input torque to both Ring and Carrier with output to Sun

10) Input to Sun with output torque split between Carrier and Ring

11) Input to Ring with output split between Carrier and Sun

12) Input to Carrier with output split between Sun and Ring

All of these states have further sub states depending on direction of rotation of the components and the relative speed of the components when designing using a split power strategy.

Any design that uses only one wedging roller associated with a planet operates as a one way clutch in one direction or one torque application state. If we consider one such design in which one roller is used so as to allow input torque to any leg with one leg fixed it can only avail itself of the following states:
1. Carrier fixed with torque input to the Sun and output the Carrier (in clockwise direction)
2. Carrier fixed with torque into the Ring and output to the Sun (in anticlockwise direction)
3. Sun fixed with torque input from Ring and Carrier output (in anticlockwise direction)
4. Sun fixed and torque input to Carrier with Ring the output (in clockwise direction)
5. Ring fixed with torque input to Carrier and output to Sun (in clockwise direction)
6. Ring fixed with torque input to Sun and Carrier the output (in anticlockwise direction)

Some “split power” states will be possible but only in one direction and within certain limits of proportional torque or speed of the inputs. The application of wedging systems that use only a single wedging roller is accordingly limited.

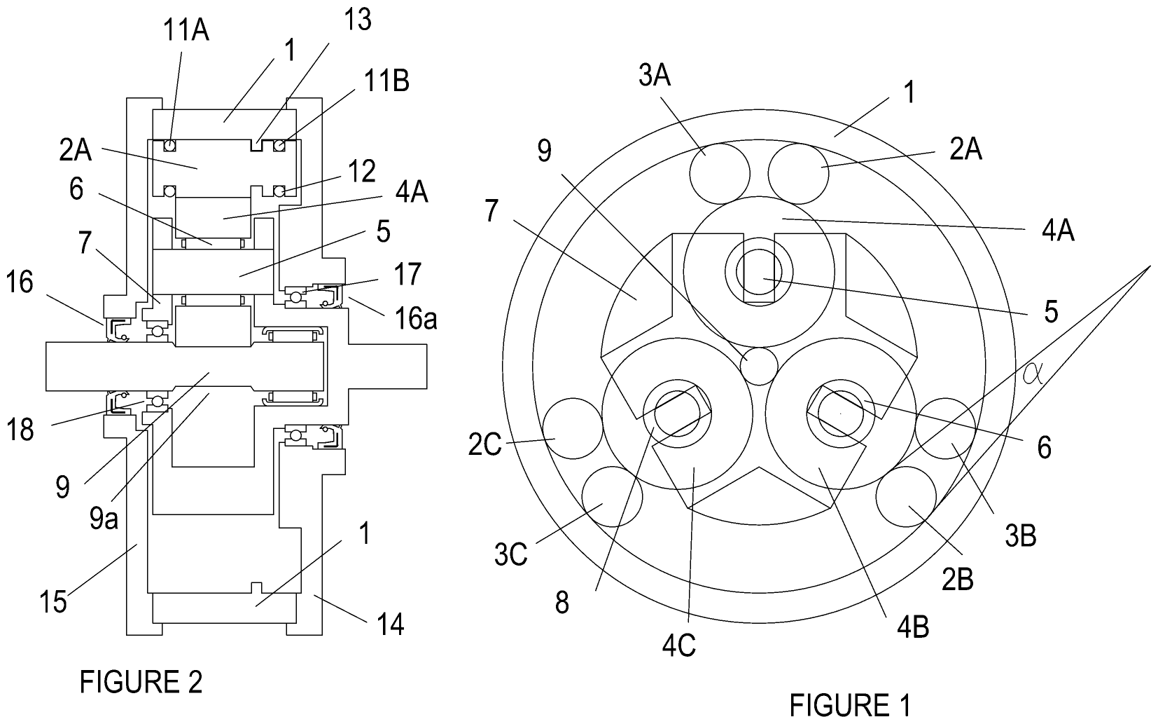

A first illustrative example will be described with reference to FIGS. 1 and 2, in which can be seen the ring 1, the planet rollers 4A, 4B and 4C, and the sun (shaft) 9. The planet rollers 4A, 4B and 4C are supported on axles 5 running in respective needle roller bearings 6 which in turn are supported in slots in a carrier 7. Carrier 7 can also perform the function of the output drive in some implementations.

Adjacent to each planet roller 4A, 4B, 4C are provided two additional wedge rollers, respectively 2A, 3A; 2B, 3B; 2C, 3C. Considering for example planet roller 4A, rollers 2A and 3A are located so that at when touching the surface of planet roller 4A, and the inner surface of ring 1, the tangents to the points of contact form a wedging angle α1 that is responsible for creating the active clamping force. The angle α1, the wedging angle, can be readily seen in FIG. 1A. The mechanism of engagement between the wedge rollers 2A, 3A, planet roller 4A and ring 1 ensures that the clamping force remains relatively proportional to the torque being applied to the sun-shaft.

For the purposes of this specification and claims, the term wedging angle is the angle defined by the tangents of the engagements of a wedge roller with, on the one hand, the ring and, on the other hand, the planet roller.

FIG. 1a shows how the traction forces T1, and T2, force the wedge rollers into the wedge angle α1 creating the normal forces N1 and N2 which fully balance the traction forces. The force N2 is transferred down through the planet roller to the sun creating the force N3 resisted by the Sun. These normal forces N2 and N3 require a balancing force from the carrier, N4 combined with the traction forces T3 and T4 to stabilize the planet and this force creates a torque in the carrier 7. Because α2 is always larger than al there is always a positive (N4) force required creating torque in the carrier 7. In this way all of the traction force on the wedge rollers is available to create the normal forces.

Unlike the prior art, implementations of the present invention do not use a pivoting support and the planet rollers and wedge rollers are not locked into a common support structure. According to implementations of the present invention, the α1 angle is such that Tan of half of this angle (not the angle itself) must be less than the friction coefficient or, if operating as a traction device, must be less than the traction coefficient. This results in a mechanism that can use an angle roughly twice the size of the angle needed in the prior art making this mechanism much less sensitive to mechanical accuracy and the deflections that accompany its operation when delivering high torques. To compare the present implementation to the design proposed in U.S. Pat. No. 8,092,332 to Ai, (Timken), in that design only around half of the traction forces are available because of the adoption of the pivoting arrangement, requiring the wedging angle to be around half the size in order to create sufficient wedging force to ensure that the wedging initiates.

The other weakness associated with using the prior art pivoting system is that the bearings supporting the planets must carry some of the clamping forces loading them up excessively. With this invention no clamping load is carried by the planet bearings only the reactions from the torque being transferred. The other weakness is that both the wedge roller bearings and planet bearings carry loads generally equal to twice the traction force at each contact that are then transferred to the pivoting support with the output torque created because these forces operate at different leverarms within the system. With the current inventions arrangement only the planet bearings supported via axles directly to the carrier carry twice the traction force resulting in roughly half the bearing losses. The wedge rollers have no bearing support and are held in position by the ring and the planet.

In applications such as electric vehicles, a device capable of effective operation in only one direction of torque is unsuitable as typically braking energy is generally captured during deceleration events, requiring the transmission to drive the motor as a generator, and often reversing the motor delivers a reverse gear state. Another issue in prior art devices is that when carrying large amounts of torque, loading the rollers up to around 4.2 GPa contact stresses, the deflections become great enough that they load up the supporting bearings lowering the efficiency.

It is also advantageous to create a wedging angle that will result in the greatest difference between the planet rollers and wedge rollers overall diameters and the gap between the surface of the sun and the inside of the ring, as in this way the mechanism becomes less sensitive to machining accuracy and deflections when under high load. It is also desirable to create a geometry that will allow the smallest sun diameter possible relative to the ring as in this way the greatest ratio reduction can be achieved. It is important to ensure that mechanical wear does not occur at the surfaces of the rollers and the ring and to lubricate the bearings. For this reason it is almost essential to run the device in the presence of lubricant.

When a device such as the implementations of the present invention is run at high speed with lubricant present, a fluid film develops between the rolling surfaces and the tangential force required to be transferred from one surface to the other can no longer be achieved using friction because of the presence of the fluid film. It is important then that the fluid selected is of a type that exhibits a traction coefficient that is similar to the friction coefficient. These fluids are often referred to as traction fluids and they can exhibit around 25% the dry friction coefficient and perhaps 50% of the lubricated friction coefficient. The wedging angles are therefor related not just to the friction coefficient but to the traction coefficient. For this reason it is important to arrange for a geometry that maximises the dimensional difference between the minimum gap in the wedge and the rollers that are wedged into it, if it is intended to run the device at high speed.

It can be seen that, as a matter of geometry, in order for both wedge rollers to be able to move into the wedge space without touching each other they must be below a certain critical size which is found to be around 14% of the ring diameter. However, it is also possible to provide (in an alternative implementation) a one way mechanism using a larger wedge roller than could be used for two way action. It is also possible to use larger wedge rollers that would both fit into the wedging gap using a mechanism that would allow one roller to move into and one out of the wedge without touching each other as the direction of torque or rotation is changed.

It is often most advantageous to design these systems with the highest ratio possible. It can be seen that sun diameter must be large enough to ensure that the three planets do not touch and so with the wedge rollers restricted to around 14% of the diameter of the ring the sun diameter is similarly restricted to be in practice no smaller than 6.6% of the diameter of the ring delivering a ratio reduction of 15:1 (although the theoretical maximum ratio can be as high as 18:1 while the pair of wedge rollers are arranged to simultaneously touch the planet but not touch other). It is also understood that either the carrier or the ring can be held still with the other, carrier or ring, being the output. When the ring is the output the ratio is the direct relationship of the sun diameter to the ring and when the carrier is the output it is this ratio minus 1. The maximum reduction ratio using the ring as the output is then 15:1 while if the carrier is used it is 14:1. It is also possible for all three components to rotate at the same time.

In these implementations of the present invention, a method of applying preload to the wedging planets is used, to ensure that the wedging process is initiated. When a large preload is applied it is also possible to increase the wedge angle and make the mechanism less reliant on accuracy of machining of the wedge rollers.

Referring again to FIG. 2, two supporting plates 14, 15 are attached over ring 1 so as to provide additional stiffness to ring 1, reducing the deflections when under load without the necessity for ring 1 to be excessively thick. Plate 14 is in turn supported on bearing 17, to ensure that ring 1 remains concentric with the sun 9. The planet rollers 4 are free to move radially in and out towards or away from the sun 9. In this way the bearings 8 are never carrying any of the loading forces in the system, only the reaction forces off the contacts of the planet rollers 4A, 4B and 4C with sun 9 and the wedge rollers 2A, 2B, 2C, 3A, 3B, 3C.

The inclined normal force onto the planet rollers 4A, 4B and 4C from the respective wedge rollers 2A, 2B, 2C, 3A, 3B, 3C produces a component of force that is carried by the sides of the slot in the carrier 7 via the axle 5 and the bearing 8 passing through the planet rollers 4A, 4B, 4C. The planet rollers 4A, 4B, 4C at all times bear directly onto the sun 9 with a force equal to the reaction force from the respective wedge roller divided by COS of the angle formed between this radial line and the direction of the Normal force off the wedge roller onto the planet. This force will always be sufficient to ensure that slip does not occur provided the TAN of half the wedging angle α1 is less than the coefficient of friction or traction at the contact. The slots in carrier 7 can be offset or angled to modify this relationship so as to favour clamping for either forward or reverse torque by modifying the direction in which the Normal force N3 (FIG. 1a) acts.

Axles 5 are slidably mounted, so that they can slide towards and away from the central axis along the slots in the carrier 7. The slots constrain the axles 5 to remain in the correct radial position. The axles are preferably mounted on the planet rollers so as to permit radial play, so as to accommodate deflections generated while carrying torque and avoid loading the axle or its bearing with the radial component of any normal forces. This may be for example by mounting the axles on a slightly oversized hole in the planet roller.

The wedge rollers in each pair, for example 2A, 3A, are pulled together in this case with two elastomeric rings 11A, 11B stretched over slots in the wedge rollers, so as to pre-load them with a force required to initiate a wedging action. Ring 1 is provided with a tooth 13 on its inside surface that engages with a slot in one or both ends of the wedge rollers 2A, 3A to ensure that each wedge roller 2A, 3A (for example) remains in the correct axial position. The planet rollers 4A, 4B, 4C are held in the correct axial position using a groove 9a formed in the sun 9. Ring 1 is constrained axially using deep groove bearings 17 while sun 9 is retained axially using bearing 18. Two seals 16 & 16a allow the case to be part filled with lubrication fluid.

When rotational torque is applied to the sun 9, the light preload applied by the elastomeric rings 11A, 11B causes the planet rollers 4A, 4B, 4C to rotate, which in turn rotates wedge rollers 2A, 2B, 2C, 3A, 3B, 3C and ring 1. If a resistance to the output torque is applied then the traction forces (T1 and T2) that exist at the ring and wedge roller surface urges the roller with a force equal to twice the individual traction forces (2T1) into the slot which in turn creates a normal force at the surface equal to 2F/TAN α or F/TAN (α/2) In order for the component of the normal force to fully resist the force 2T1 at all times the friction coefficient and the traction coefficient must always be more than TAN α/2 when the amount of preload is very small relative to the full torque forces. If these coefficients are less than this value then the wedging will not initiate and the maximum torque transfer will be related only to the initial preload.

It is possible to provide significant preload using a very stiff elastomer or a stiff ring, for example as in the implementation of FIG. 9, that is flexed over the wedge rollers or over small shafts 25 formed on the end of each wedge roller. When this is done the Normal force will become the sum of 2F/TAN α/2+the preload force/Tan α/2 allowing a to become larger. It can readily be seen that the machine will benefit from the use of a lubricant that exhibits a high traction coefficient particularly if the machine is intended to operate at high speeds. Maintaining the 2F/TAN α/2 relationship will also ensure that the tangential force created at the sun is fully capable of being carried without excessive slip because the normal force onto the sun 9 is (when the axis of the slot passes directly through the sun centre) the normal force divided by the COS of the angle formed by the normal force from the planet to the sun and the planet to the wedge roller. It is necessary to ensure that the normal force from the planet rollers onto the sun is always equal or greater than the normal force of the planet rollers onto the wedge roller.

The elastomeric belt used to apply preload force or elastic ring can be replaced with magnets arranged and fixed on the ends of the wedge rollers so that they pull the rollers towards each other as seen in FIGS. 4 and 6 using magnetic attraction. FIG. 6 and FIG. 4 shows the wedge rollers 2G, 2H with magnets with North and South poles arranged so as they are attracted to each other. Additional magnets 19a that push the rollers towards each other using magnetic repulsion can be fixed in the carrier 7 to increase the force.

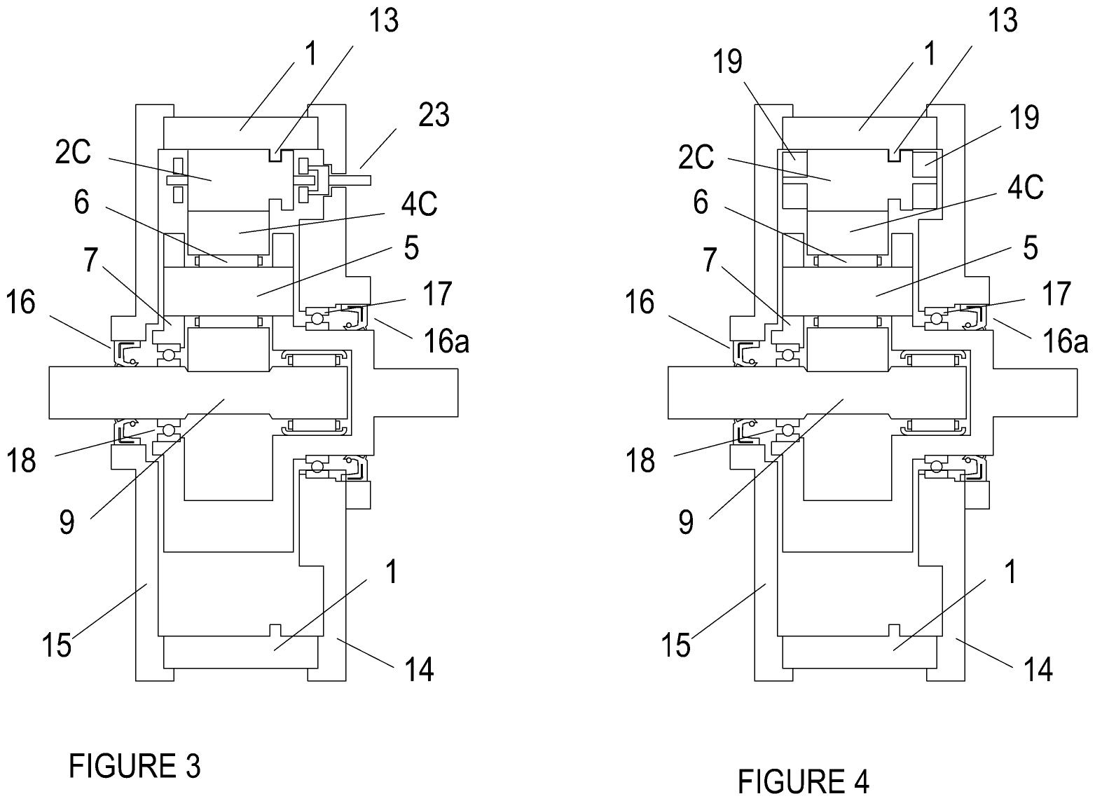

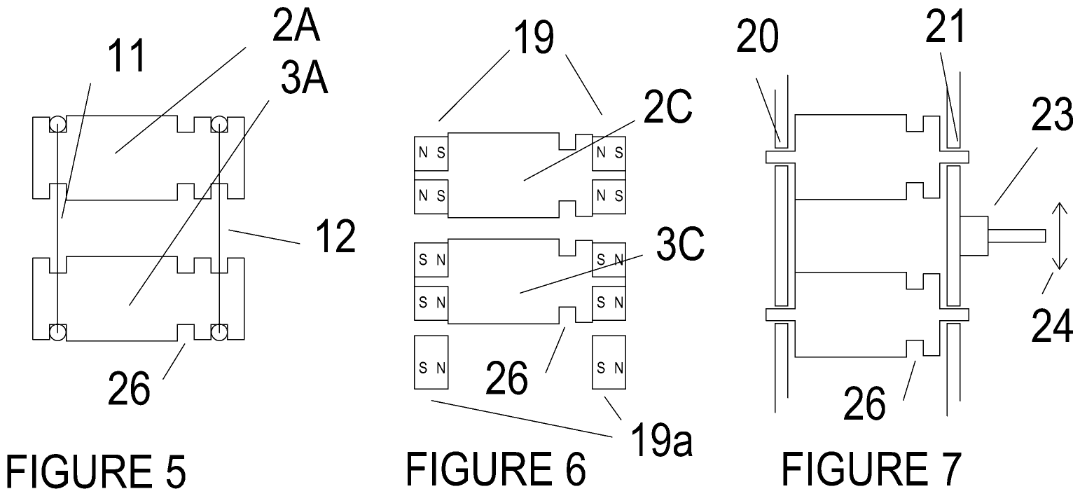

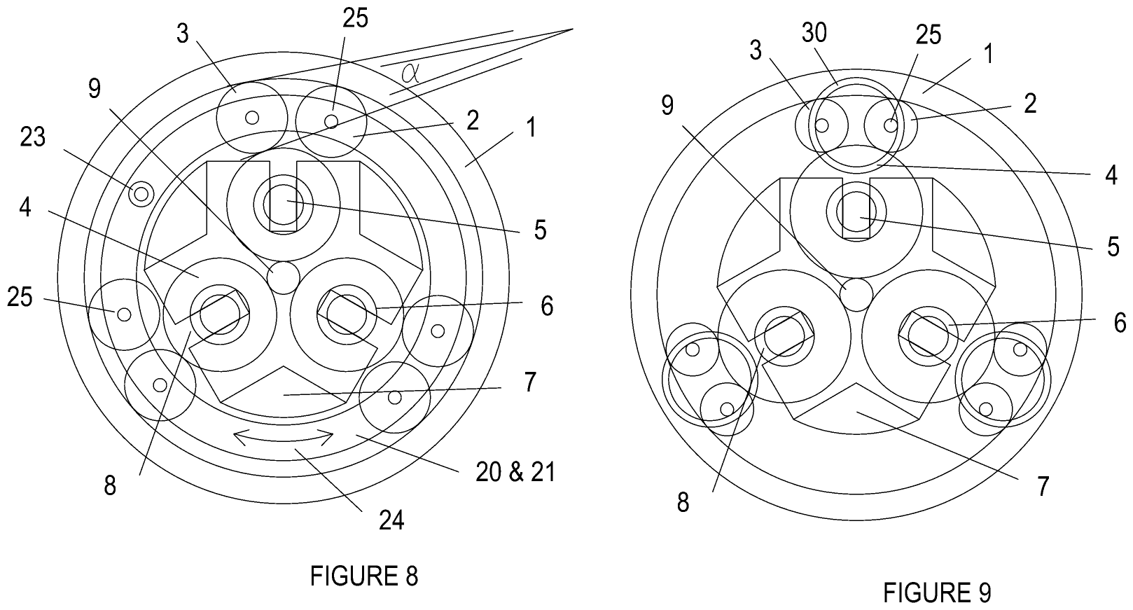

Another alternative implementation is illustrated with reference to FIGS. 3, 7 and 8. In this implementation, the preload force is provided by rings 20 and 21 that support both sides of all six rollers on small axles 25 so that the pairs of rollers can be rotated clockwise or anticlockwise as shown with arrows 24 using an actuator 23. In this way the system can accept clockwise or anticlockwise torque and adopt a neutral with neither roller set moved into a position where it will wedge. In all cases the groove 26 in the wedge rollers remains sufficiently engaged with the tooth 13 in the ring. With this method although it needs some form of active actuation the wedge rollers can be larger than 14% of the ring diameter and the ratio of the diameter of the sun to diameter of ring can be increased.

Another alternative implementation in FIG. 9 uses flexible but relatively stiff rings 30 (two required for each pair but only one visible) pressed over axles 25 on each side of the wedge rollers 2, 3 so as to provide significant preload force. The rings rotate over the small shafts so very little friction resistance is encountered.

Another alternative is shown in FIG. 10, in which bearing assemblies 27 are fitted over shafts in the ends of the wedge rollers and a spring 28 clipped over the outer ring of the two bearings is used to apply the preload force.

It can be seen that when the ratio required is smaller, for example like 6:1, the sun reaches proportions that will allow four planet rollers and when 4:1 it will allow 5 and when 3:1 it will allow 6. It is also clear to see that if only two planet rollers were used the sun could become infinitely small before the planets would touch allowing much higher reduction ratios.

While the present invention has been described primarily in relation to arrangements with 2 wedge rollers for each planet roller, aspects of the present invention could be applied to a single wedge roller system.

It can be seen that when all three wedge rollers (in a 3 planet roller system) move into the wedging gap equally that all of the forces can be balanced. However even very small errors in mechanical accuracy will deny this and three different normal or clamping forces will develop. It is important then to ensure that the bearing support of the sun and the ring remain as concentric as possible since any imbalance in forces must be carried by the bearings that support both the sun and the ring.

It will be appreciated that the present invention can be implemented in other forms, with changes that are necessary or desirable, dependent on the intended application of the drive. It can readily be seen that for someone skilled in the art similar solutions can be found that will deliver similar functionality. This example is for illustrative purposes to demonstrate the benefits of the invention in a general sense.

1. An epicyclic traction drive transmission, including a carrier having a central axis, a sun shaft rotationally mounted within the carrier and positioned in the central axis, a plurality of planet rollers mounted on the carrier and arranged to rotate on respective angularly equidistant axles, the axles being slidably mounted in slots within the carrier so that the planet rollers are adapted to move towards and away from the central axis, and rotationally engage the sun shaft; at least one wedge roller associated with each planet roller, the wedge roller being free to translate relative to the carrier; and an outer ring, co-axial with the central axis; wherein each wedge roller engages the outer ring and respective planetary roller with a frictional or traction coefficient μ, and the wedge roller defines a wedging angle α, such that tan α/2 is less than μ.

2. A transmission according to claim 1, wherein the wedge rollers are pre-loaded so as to be forced into the gaps between the planet rollers and the ring, in a direction that will ensure that the traction forces that develop for the desired rotation state add to the preload force

3. A transmission according to claim 1 in which: the ring is held stationary and the carrier rotates; or the carrier is held stationary and the ring rotates: or all of the ring, carrier and sun shaft rotate.

4. A transmission according to claim 5, wherein at least one of the plates are mounted on a plate bearing, to facilitate rotation around the central axis.

5. A transmission according to claim 2, wherein the axles are mounted on the planet rollers so as to permit radial play, so as to accommodate deflections generated while carrying torque and avoid loading the axles or their bearings with the radial component of any normal forces.

6. A transmission according to claim 2, wherein both edges of the ring are supported by respective plates, so as to stiffen the ring against the normal forces that develop on its inner surface.

7. An epicyclic traction drive transmission, including a carrier having a central axis, a sun shaft rotationally mounted within the carrier and positioned in the central axis, a plurality of planet rollers mounted on the carrier and arranged to rotate on respective angularly equidistant axles, the axles being slidably mounted in slots within the carrier so that the planet rollers are adapted to move towards and away from the central axis, and rotationally engage the sun shaft; a first and second wedge roller associated with each planet roller, each wedge roller being free to translate relative to the carrier; and an outer ring, co-axial with the central axis; wherein each pair of first and second wedge rollers are biased by a preload force into the respective gap between the ring and each side of the planet roller, so that a wedging force is operatively created between the wedge roller, the planet roller and ring regardless of the direction of rotation.

8. A transmission according to claim 7, wherein first and second wedge roller is biased towards each other by an elastic belt or ring which engages the first and second wedge roller.

9. A transmission according to claim 8, wherein first and second wedge roller is biased towards each other by an elastic belt or ring.

10. A transmission according to claim 7, wherein the first and second wedge rollers are biased towards each other by a magnetic force.

11. A transmission according to claim 10, wherein the first and second wedge rollers are biased towards each other by a magnetic force of attraction between magnets associated with each wedge roller.

12. A transmission according to claim 10, wherein the first and second wedge rollers are biased towards each other by a magnetic force of repulsion between magnets associated with each wedge roller and magnets associated with the carrier.

13. A transmission according to claim 7, wherein the wedge rollers are supported in a ring, so that by rotating the ring one or other the first and second wedge rollers in each set is forced into the wedging gap between the ring and planet roller, so as to accommodate torque or rotation in a selected direction, or allow selection of a position in which neither first or second wedge rollers can be forced into the wedging gap by active torques in either direction.
